(19) United States
(12) Patent Application Publication
(10) Pub. No.: US 2008/0175127 A1
(43) Pub. Date: Jul. 24, 2008

(54) Holographic Recording And/Or Read-Out Device And Holographic Carrier

(75) Inventors: Coen Theodorus Hubertus Fransiscus Liedenbaum, Eindhoven (NL); Frank Jeroen Pieter Schuurmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/910,751

(22) PCT Filed: Apr. 6, 2006
(86) PCT No.: PCT/IB2006/051057

§ 371 Date: Oct. 5, 2007

(30) Foreign Application Priority Data
Apr. 11, 2005 (EP) 05300274.7

(51) Int. Cl. G11B 7/0065

(52) U.S. Cl. 369/103

(57) ABSTRACT

The invention relates to a holographic device for writing data in and/or reading-out data from a holographic information carrier. The holographic information carrier comprises a plurality of patterns recorded with a plurality of corresponding recording multiplexing parameters. The holographic device comprises means for detecting one of the patterns and means for associating the detected pattern with the corresponding recording multiplexing parameter. The invention also relates to a corresponding read-out method and a corresponding recording method.

### FIELD OF THE INVENTION

The present invention relates to a holographic device for writing data in and/or reading-out data from a holographic information carrier. It also relates to a method for reading out a data page recorded in a holographic information carrier, as well as to a method for recording a data page in a holographic information carrier. It also relates to a holographic information carrier.

The invention is particularly relevant to retrieve multiplexing parameters used for recording data pages in a holographic information carrier.

### BACKGROUND OF THE INVENTION

An optical device capable of recording data in and reading data from a holographic medium is known from H. J. Coufal, D. Psaltis, G. T. Sincerbox (Eds.), ‘Holographic data storage’, Springer series in optical sciences, (2000). FIG. 1 shows such an optical device. This optical device comprises a radiation source 100, a collimator 101, a first beam splitter 102, a spatial light modulator 103, a second beam splitter 104, a lens 105, a first deflector 107, a first telescope 108, a first mirror 109, a half wave plate 110, a second mirror 111, a second deflector 112, a second telescope 113 and a detector 114. The optical device is intended to record in and read data from a holographic medium 106.

During recording of a data page in the holographic medium, half of the radiation beam generated by the radiation source 100 is sent towards the spatial light modulator 103 by means of the first beam splitter 102. This portion of the radiation beam is called the signal beam. Half of the radiation beam generated by the radiation source 100 is deflected towards the telescope 108 by means of the first deflector 107. This portion of the radiation beam is called the reference beam. The signal beam is spatially modulated by means of the spatial light modulator 103. The spatial light modulator 103 comprises addressable elements that can be addressed as transmissive areas and absorbent areas, which correspond to zero and one data-bits of a data page to be recorded. After the signal beam has passed through the spatial light modulator 103, it carries the signal to be recorded in the holographic medium 106, i.e. the data page to be recorded. The signal beam is then focused on the holographic medium 106 by means of the lens 105.

The reference beam is also focused on the holographic medium 106 by means of the first telescope 108. The data page is thus recorded in the holographic medium 106, in the form of an interference pattern as a result of interference between the signal beam and the reference beam. Once a data page has been recorded in the holographic medium 106, another data page is recorded at a same location of the holographic medium 106. To this end, data corresponding to this data page are sent to the spatial light modulator 103. The first deflector 107 is rotated so that the angle of the reference signal with respect to the holographic medium 106 is modified. The first telescope 108 is used to keep the reference beam at the same position while rotating. An interference pattern is thus recorded with a different pattern at a same location of the holographic medium 106. This is called angle multiplexing. A same location of the holographic medium 106 where a plurality of data pages is recorded is called a book.

Alternatively or additionally, the wavelength of the radiation beam may be tuned in order to record different data pages in a same book. This is called wavelength multiplexing. Other kinds of multiplexing, such as shift multiplexing, may also be used for recording data pages in the holographic medium 106. As a consequence, in order to record a plurality of pages in a same book, a multiplexing parameter has to be modified. In the following, the expression “multiplexing parameter” is used to identify, for example, a specific angle of the reference beam with respect to the information carrier, or a specific wavelength of the radiation source 100. It is also possible that two or more kinds of multiplexings are used for recording data pages. For example, the angle of the reference beam with respect to the information carrier as well as the wavelength of the radiation source 100 may be varied in order to record different data pages in a same book. In this example, a data page is recorded with a specific angle and a specific wavelength. In this case, the expression “multiplexing parameter” is used to identify a combination angle-wavelength. In other words, the expression “multiplexing parameter” is used to identify the variable parameter or parameters that are used for recording a specific data page in a book.

During readout of a data page from the holographic medium 106, the spatial light modulator 103 is made completely absorbent, so that no portion of the beam can pass trough the spatial light modulator 103. The first deflector 107 is removed, such that the portion of the beam generated by the radiation source 100 that passes through the beam splitter 102 reaches the second deflector 112 via the first mirror 109, the half wave plate 110 and the second mirror 111. If angle multiplexing has been used for recording the data pages in the holographic medium 106, and a given data page is to be read out, the second deflector 112 is arranged in such a way that its angle with respect to the holographic medium 106 is the same as the angle that was used for recording this given hologram. If for instance wavelength multiplexing has been used for recording the data pages in the holographic medium 106, and a given data page is to be read out, the same wavelength is used for reading this given data page. In other words, a data page is read-out at a same multiplexing parameter as the multiplexing parameter used for recording said data page.

The reference signal is then diffracted by the information pattern, which creates a reconstructed signal beam, which then reaches the detector 114 via the lens 105 and the second beam splitter 104. An imaged data page is thus created on the detector 114, and detected by said detector 114. The detector 114 comprises pixels or detector elements, each detector element corresponding to a bit of the imaged data page.

However, in such an optical device, it is very difficult to set the multiplexing parameter used during read-out of a data page identical to the multiplexing parameter used for recording said data page. Actually, it could be possible to standardize the holographic recording in such a way that a specific data page is recorded with a specific multiplexing parameter. As an example, it could be possible to decide that the first page of a book will be recorded with a wavelength of 405 nanometers, the second page with a wavelength of 405.1 nanometers, the third page with a wavelength of 405.2 nanometers and so on. Then, when one wants to retrieve, for example, the tenth page of a book, the holographic read-out device sets the wavelength of the radiation source 100 at 405.9 nanometers. However, with current available radiation sources, it is not possible to reach such a precision in the wavelengths, especially in end-user holographic read-out devices. Moreover, the wavelength of a radiation source may vary, for instance, as a function of the temperature. Therefore it would be very difficult in this case to set the wavelength of the radiation source 100 in such a way that the required data page is read-out. As an example, if one tries to retrieve the tenth data page of a book with a wavelength of 405.9 nanometers, but, due to temperature conditions, the actual wavelength of the radiation source is 405.6 nanometers, then the seventh data page will be read instead of the tenth. This could be even worse if, due to temperature conditions, the actual wavelength of the radiation source is 405.85 nanometers, because in this case no data page will be read or the quality of the detected data page will be bad. Actually, the Bragg selectivity of a holographic information carrier is such that if the read-out wavelength slightly differs from the recording wavelength, then the diffraction efficiency of the data page strongly decreases.

It could also be possible, before read-out of the holographic information carrier, to make a complete scan of the read-out multiplexing parameter through the permissible range of multiplexing parameters, in order to find an appropriate signal on the detector. This would however take a relatively long time, which is not acceptable in data storage devices.

### SUMMARY OF THE INVENTION

It is an object of the invention to provide means for ensuring that a multiplexing parameter used for reading-out a recorded data page is the same as the multiplexing parameter used for recording said data page, said means providing fast access to the recorded data page.

To this end, the invention proposes a holographic device for writing data in and/or reading-out data from a holographic information carrier, said holographic information carrier comprising a plurality of patterns recorded with a plurality of corresponding recording multiplexing parameters, said holographic device comprising means for detecting one of the patterns and means for associating the detected pattern with the corresponding recording multiplexing parameter.

According to the invention, specific patterns associated with the multiplexing parameters that have been used or have to be used for recording data pages in the holographic information carrier are pre-recorded in the holographic information carrier. When one of these patterns is read-out with a read-out multiplexing parameter, the recording multiplexing parameter associated with the detected pattern is compared to said read-out multiplexing parameter. If the recording multiplexing parameter associated with the detected pattern is different from said read-out multiplexing parameter, then the read-out multiplexing parameter is modified and another pattern is detected until the recording multiplexing parameter associated with the detected pattern is the same as the read-out multiplexing parameter. A recorded data page can then be accessed in a few steps only, which makes such an access relatively fast.

In an advantageous embodiment, the means for associating the detected pattern with the corresponding recording multiplexing parameter comprise means for reading a digital key provided by a user.

According to this advantageous embodiment, a digital key is required for reading data from and/or writing data in the holographic information carrier. This digital key may be provided with the holographic information carrier. This is especially useful for digital rights management, as only an authorized user will be able to read or record this holographic information carrier.

The invention further relates to a method for reading out a data page recorded with a first recording multiplexing parameter in a holographic information carrier comprising a plurality of patterns recorded with a plurality of corresponding recording multiplexing parameters, said method comprising the steps of:
a) operating at a first read-out multiplexing parameter;
b) detecting one of the patterns;
c) associating the detected pattern with the corresponding recording multiplexing parameter;
d) if the corresponding recording multiplexing parameter differs from the first recording multiplexing parameter, operating at a different read-out multiplexing parameter;
e) repeating steps b), c) and d) until the corresponding recording multiplexing parameter matches the first recording multiplexing parameter;
f) reading out the data page with the current read-out multiplexing parameter.

The invention further relates to a method for recording a data page with a first recording multiplexing parameter in a holographic information carrier comprising a plurality of patterns recorded with a plurality of corresponding recording multiplexing parameters, said method comprising the steps of:
a) operating at a first read-out multiplexing parameter;
b) detecting one of the patterns;
c) associating the detected pattern with the corresponding recording multiplexing parameter;
d) if the corresponding recording multiplexing parameter differs from the first recording multiplexing parameter, operating at a different read-out multiplexing parameter;
e) repeating steps b), c) and d) until the corresponding recording multiplexing parameter matches the first recording multiplexing parameter;
f) recording the data page with the current read-out multiplexing parameter.
   According to this recording method, specific patterns are pre-recorded on an information carrier. These specific patterns are associated with recording multiplexing parameters in the recording holographic device. Before writing a data page, at least one of the specific patterns is read-out in order to set the recording multiplexing parameter at a standardized value.

In an advantageous embodiment, the step of associating the detected pattern with the corresponding recording multiplexing parameter comprises a step of reading a digital key provided by a user.

The invention further relates to a holographic device comprising means for storing a set of patterns associated with corresponding recording multiplexing parameters and means for writing said patterns in a holographic information carrier.

This optical device is able to write the specific patterns associated with the recording multiplexing parameters. As a consequence, in order to write data pages in a holographic information carrier with such a writing device, the holographic information carrier does not need to have specific pre-recorded patterns.

Advantageously, this holographic device comprises means for detecting in the holographic information carrier a first portion of recording medium having a first thickness and a second portion having a second, lower thickness and means for writing said patterns in said second portion.

As described in the detailed description, recording of the specific patterns in a thinner portion of the recording medium allows easier retrieval of the recording multiplexing parameters.

The invention also relates to a holographic information carrier comprising a recording medium comprising a first portion having a first thickness and a second portion having a second, lower thickness.

These and other aspects of the invention will be apparent from and elucidated with reference to the embodiments described hereinafter.

### BRIEF DESCRIPTION OF THE DRAWINGS

The invention will now be described in more detail by way of example with reference to the accompanying drawings, in which:

FIG. 1 shows a conventional holographic data storage system;

FIG. 2 shows a first example of specific patterns associated with multiplexing parameters;

FIGS. 3a and 3b respectively show a second and a third example of specific patterns associated with multiplexing parameters;

FIGS. 4a to 4c show associating means used in a recording and/or read-out holographic device in accordance with the invention;

FIG. 5 illustrates a recording method in accordance with the invention;

FIG. 6 illustrates a read-out method in accordance with the invention.

### DETAILED DESCRIPTION OF THE INVENTION

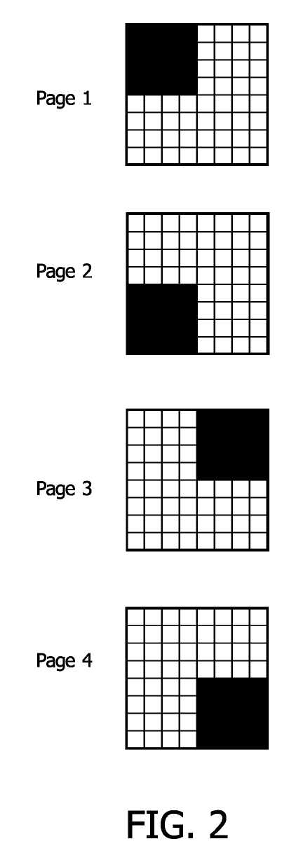

FIG. 2 shows a first example of specific patterns associated with recording multiplexing parameters. FIG. 2 shows four pages of a book that are pre-recorded in a holographic information carrier. The first page is pre-recorded at a first recording multiplexing parameter and comprises a first pattern, the second page is pre-recorded at a second recording multiplexing parameter and comprises a second pattern, the third page is pre-recorded at a third recording multiplexing parameter and comprises a third pattern and the fourth page is pre-recorded at a fourth recording multiplexing parameter and comprises a fourth pattern. The four patterns differ from each other. In the example of FIG. 2, the holographic information carrier is intended to be read or written at four different multiplexing parameters. This is only an illustrative example, as the number of multiplexing parameters is usually higher, usually in the order of 100.

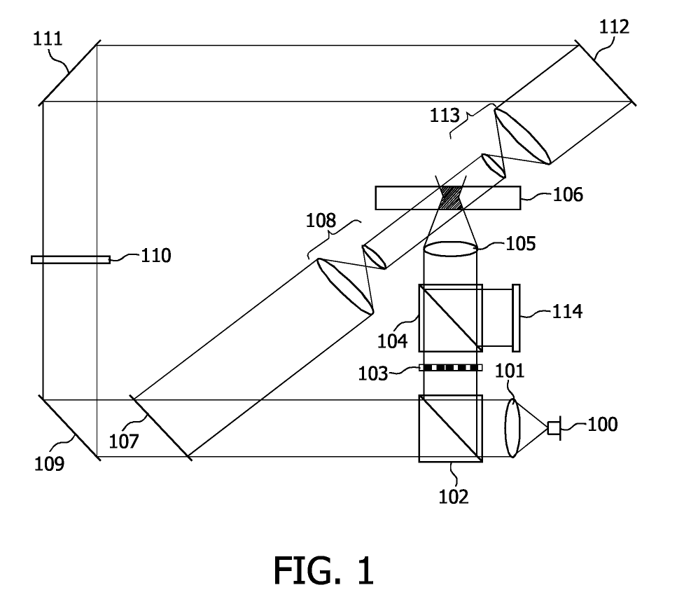

In order to pre-record the specific pattern in the holographic information carrier, a holographic device as described in FIG. 1 may be used. First, the optical system of the device of FIG. 1 is positioned in order to write the book of FIG. 2 at a specific place, in such a way that this book may be further easily retrieved by a read-out and/or recording device in accordance with the invention. For example, the optical system of the device of FIG. 1 may be positioned in order to write the book of FIG. 2 in a corner of the holographic information carrier, or in the center of the information carrier. Alignment marks recorded on a surface of the holographic information carrier may also be used for positioning the optical system.

It should be noted that the specific patterns do not need to be written in a same book. The specific patterns may be written in many books. It is also possible that a same specific pattern is recorded in many books, which facilitates retrieval of said pattern.

Once the optical system of the device of FIG. 1 has been adequately positioned, the device of FIG. 1 is operated at the first recording multiplexing parameter and the first specific pattern is sent to the spatial light modulator 103 in order to be written in the holographic information carrier in the way described in the description of FIG. 1. The device of FIG. 1 is then operated at the second recording multiplexing parameter and the second specific pattern is sent to the spatial light modulator 103 in order to be written in the holographic information carrier. This is repeated for all specific patterns that are to be recorded in the holographic information carrier.

The book depicted in FIG. 2 may be pre-recorded on a blank holographic information carrier, by means of a holographic recording device. This may be done in a manufacturing process, where the recording multiplexing parameters can be controlled with a high accuracy, which is not possible with a conventional end-user holographic recording device. Actually, in a holographic recording device used in a factory, it is possible, in the case of wavelength multiplexing for example, to use a radiation source having a very accurate wavelength control. Such a radiation source is expensive and cannot be used in a holographic recording device for consumer electronics. It is also possible, in a factory, to control the ambient temperature in order to accurately control the wavelength.

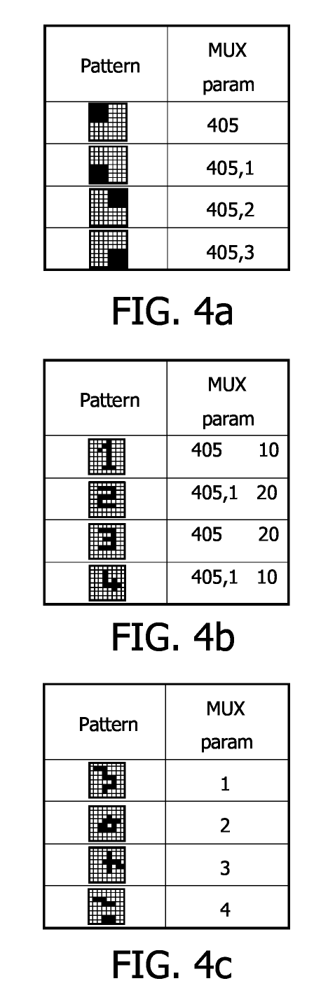

However, as will be shown in the description of FIG. 4, it is not needed that the specific patterns are recorded at accurately defined recording multiplexing parameters. Therefore, the book depicted in FIG. 2 may be recorded by a user by means of a conventional end-user holographic recording device.

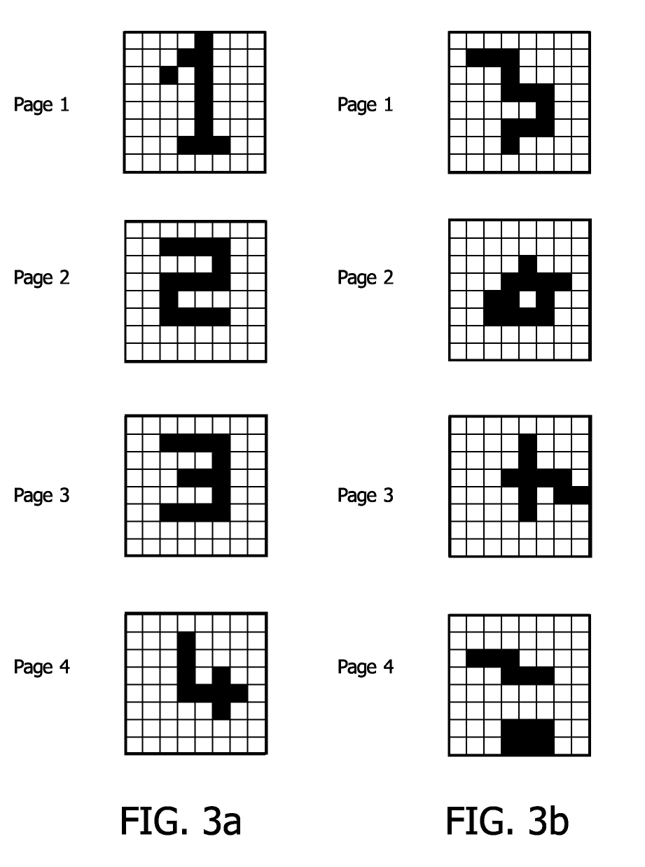

FIGS. 3a and 3b show other examples of specific patterns that may be pre-recorded in a holographic information carrier in accordance with the invention. As can be seen from FIGS. 3a and 3b, the shape of the specific patterns can be randomly chosen, as soon as the holographic device that will use these pre-recorded specific patterns comprises means for detecting said specific patterns and means for associating a specific pattern with the recording multiplexing parameter with which said pattern has been recorded. This is described in detail in the following Figs.

FIG. 4a shows associating means for associating a detected pattern with the corresponding recording multiplexing parameter. The example of FIG. 4a shows how the patterns of FIG. 2 are associated with corresponding recording multiplexing parameters. In the example of FIG. 4a, the associating means comprise a table, which gives a correspondence between the detected patterns and the corresponding recording multiplexing parameters.

A device in accordance with the invention comprises means for detecting one of the patterns and means for associating the detected pattern with the corresponding recording multiplexing parameter. In the following example, it is considered that the patterns of FIG. 2 are pre-recorded in a book of a holographic information carrier by means of a holographic recording device in a factory. It is presumed that the first pattern has been recorded with a first wavelength that exactly equals 405 nanometers, the second pattern has been recorded with a second wavelength that exactly equals 405.1 nanometers and so on.

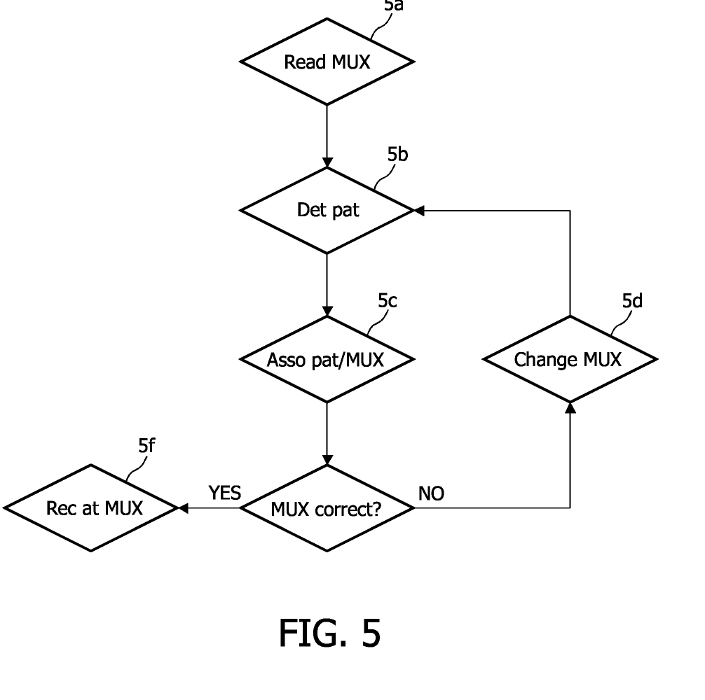

When data pages have to be recorded by a recording holographic device on a user side, instead of writing data pages with wavelengths that approximately equal 405, 405.1, 405.2 and 405.3 as in the prior art, which renders the further read-out of said data pages impossible or very difficult, a holographic recording device in accordance with the invention performs as follows. The holographic recording device first operates at a read-out wavelength that approximately equals 405 nanometers in order to write a first data page. Let us consider that this read-out wavelength is equal to 405.3 nanometers instead of 405 nanometers. The holographic recording device reads the book depicted in FIG. 2, and thus detects the fourth pattern because the first pattern has been recorded at 405.3 nanometers. Then the recording device knows that the current read-out wavelength is not correct for writing the first data page, and can tune the wavelength of the radiation source until the first pattern is detected, as described in more details in FIG. 5. This ensures that all the first data pages of all the books of the holographic information carrier will be written at the same multiplexing parameter, which is the first recording multiplexing parameter used for recording the first pattern, in this example exactly 405 nanometers.

FIG. 4b shows other associating means. The example of FIG. 4b shows how the patterns of FIG. 3a are associated with corresponding recording multiplexing parameters. As shown in FIG. 4b, the multiplexing parameter associated with the detected pattern may be a combination wavelength-angle. In this example, the first pattern is recorded at 405 nanometers with an angle of 10 degrees between the reference beam and the holographic information carrier, the second data page is recorded at 405.1 nanometers with an angle of 20 degrees and so on.

FIG. 4c shows other associating means. FIG. 4c illustrates that the multiplexing parameter does not need to be identified by its real value, because this value is indeed not needed by holographic devices in accordance with the invention. In the example of FIG. 4c, the recording multiplexing parameter that has been used for recording the first pattern is identified by the identifier 1, the multiplexing parameter that has been used for recording the second pattern is identified by the identifier 2, and so on.

The holographic recording device, in order to write a first data page, first operates at a read-out multiplexing parameter that approximately equals the first recording multiplexing parameter used for recording the first pattern. This is possible because the multiplexing parameters will be standardized, which means that, for instance, it will be decided that data pages will be written at wavelengths between 404 and 406 nanometers. A holographic recording device will thus always be able to set the wavelength of its radiation source between 404 and 406 nanometers. Let us consider that the read-out multiplexing parameter differs from the first recording multiplexing parameter, and is instead equal to the fourth recording multiplexing parameter. The holographic recording device read the book depicted in FIG. 2, and thus detects the fourth pattern because the first pattern has been recorded at the fourth recording multiplexing parameter. Then the recording device knows that the current read-out wavelength is not correct for writing the first data page, and can tune the read-out multiplexing parameter until the first pattern is detected, as described in more details in FIG. 5. This ensures that all the first data pages of all the books of the holographic information carrier will be written at the same multiplexing parameter, which is the first recording multiplexing parameter used for recording the first pattern.

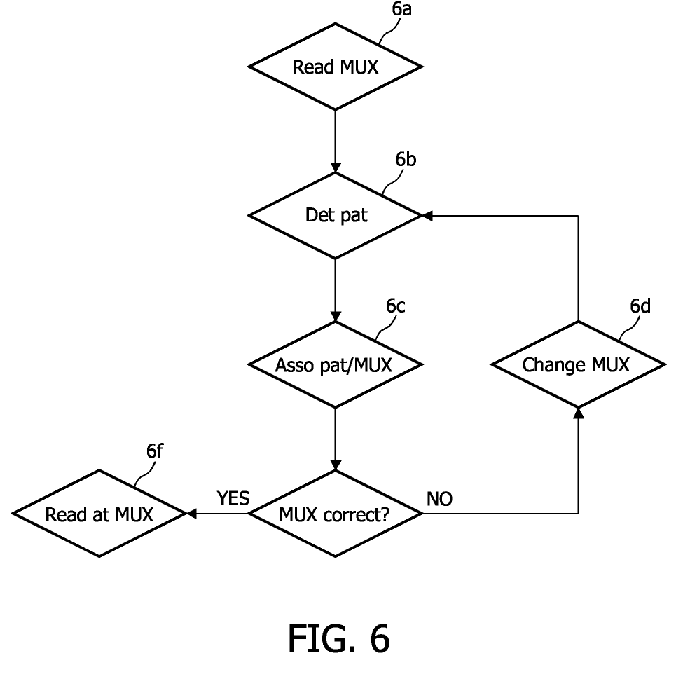

As a consequence, it is clear that the exact values of the first to fourth recording multiplexing parameters do not need to be known and thus do not need to be stored in the associating means. This means that the specific patterns associated with the recording multiplexing parameters may be pre-recorded by means of an end-user holographic recording device. Such a recording holographic device comprises means for storing a set of patterns associated with corresponding recording multiplexing parameters and means for writing said patterns in a holographic information carrier. The means for storing the set of patterns associated with corresponding recording multiplexing parameters may comprise, for example, a table such as described in FIG. 4c. Before writing data in a blank holographic information carrier, this holographic device write a specific book comprising the specific patterns mentioned in this table. It first operates at a first recording multiplexing parameter, for instance a first wavelength which does not need to be known, and write the first pattern of the table. It then operates at a second recording multiplexing parameter, which does not need to be known, and write the second pattern of the table, and so on. The specific book comprising the specific patterns associated with the recording multiplexing parameters is thus written, and can be used for writing and/or reading data as described in details in FIGS. 5 and 6.

FIG. 5 illustrates a recording method in accordance with the invention. This method is used for writing data pages in a holographic information carrier that comprises pre-recorded specific patterns associated with corresponding recording multiplexing parameters. In order to ensure that recorded data can be further read-out, it is necessary, as described in FIG. 6, that data pages are recorded with multiplexing parameters that can be further easily retrieved during read-out. As a holographic read-out device will use the pre-recorded patterns for identifying the multiplexing parameters that have been used for recording the data pages to be read, it is necessary that these data pages are recorded with the same multiplexing parameters as those used for recording the specific patterns. This can be achieved by means of the method of FIG. 5. In the following example, it is assumed that the holographic recording device intends to write a first data page in a book, with the first recording multiplexing parameter that has been used for writing the first specific pattern. At step 5a, the holographic device sets the read-out multiplexing parameter at a first value, and read the specific book comprising the specific patterns. A specific pattern is thus detected at step 5b, which specific pattern may differ from the first specific pattern because the read-out multiplexing parameter may differ from the first recording multiplexing parameter. As an example, the read-out wavelength may be 405.3 nanometers instead of 405 nanometers, as described in FIG. 4a. The detected pattern is then analyzed at step 5c, and the corresponding recording multiplexing parameter is retrieved. If the corresponding recording multiplexing parameter is equal to the first recording multiplexing parameter, then it means than the read-out multiplexing parameter is correct for writing the first data page and the holographic recording device can record the first data page with the current read-out multiplexing parameter at step 5f. If the corresponding recording multiplexing parameter differs from the first recording multiplexing parameter, then it means than the read-out multiplexing parameter is not correct for writing the first data page. As a consequence, the read-out multiplexing parameter is modified at step 5d. The preceding steps are then repeated until the corresponding recording multiplexing parameter found at step 5c is equal to the first recording multiplexing parameter. Preferably, the read-out multiplexing parameter is not randomly modified at step 5d. For instance, in the case of FIG. 4a, if the corresponding wavelength found at step 5c is equal to 405.2 nanometers, then the wavelength is decreased at step 5d. This allows retrieving the correct multiplexing parameter in only a few steps, which makes the recording method relatively fast.

FIG. 6 illustrates a read-out method in accordance with the invention. This method is used for reading data pages in a holographic information carrier that comprises pre-recorded specific patterns associated with specific recording multiplexing parameters, as well as data pages recorded according to the method described in FIG. 5. The holographic information carrier also comprises an index indicating in which data page of which book a specific data is recorded. Such an index allows knowing where a required data has to be read-out. For example, in case songs have been written in the holographic information carrier with the method of FIG. 5, the index indicates, for instance, that the first song is written in the first page of the first book, the second song in the second page of the first book, and so on. Such an index is required in order to allow retrieval of data, as is the case in other optical information carriers such as a CD or a DVD.

In order to read a specific data, a read-out device first looks in the index where the specific data is written. For example, a user wishes to listen to the second song of the album recorded in this holographic information carrier. The read-out device then knows that it has to read the second page of the first book. The optical system is then positioned in such a way that the first book can be read, in accordance with well known techniques which are outside the scope of this invention. However, once the data page that are to be read has been identified, the read-out device has to set the read-out multiplexing parameter at the multiplexing parameter that has been used for writing said data page. In the preceding example, the read-out device has to set the read-out multiplexing parameter at the second recording multiplexing parameter, because the second data page has been recorded at this multiplexing parameter, as explained in FIG. 5. The method of FIG. 6 allows setting the read-out multiplexing parameter at the right value.

At step 6a, the holographic device sets the read-out multiplexing parameter at a first value, and read the specific book comprising the specific patterns. A specific pattern is thus detected at step 6b, which specific pattern may differ from the second specific pattern because the read-out multiplexing parameter may differ from the second recording multiplexing parameter. As an example, the read-out wavelength may be 405.3 nanometers instead of 405.1 nanometers. The detected pattern is then analyzed at step 6c, and the corresponding recording multiplexing parameter is retrieved. If the corresponding recording multiplexing parameter is equal to the second recording multiplexing parameter, then it means than the read-out multiplexing parameter is correct for reading-out the second data page and the holographic recording device can read-out the second data page with the current read-out multiplexing parameter at step 6f. If the corresponding recording multiplexing parameter differs from the second recording multiplexing parameter, then it means than the read-out multiplexing parameter is not correct for reading-out the second data page. As a consequence, the read-out multiplexing parameter is modified at step 6d. The preceding steps are then repeated until the corresponding recording multiplexing parameter found at step 6c is equal to the second recording multiplexing parameter.

In the preceding description, it has been assumed that when the specific book comprising the specific patterns is read-out at a read-out multiplexing parameter, a specific pattern is always detected. However, due to the Bragg selectivity of the holographic information carrier, it is likely that if the read-out multiplexing parameter is between two recording multiplexing parameters that have been used for recording two specific patterns, no pattern will be detected. In this case, the read-out and/or recording device in accordance with the invention will have to modify the read-out multiplexing parameter until a pattern is detected, in order to implement the methods described in FIG. 5 or 6. This may lead to problems, and may slow down the access time to a data page.

In order to solve this problem, it is possible to pre-record more specific patterns than the number of read-out multiplexing parameters that will be used for reading out data pages. For example, if it has been decided to use 100 different multiplexing parameters in holography, then it is possible to pre-record 1000 specific patterns at 1000 different recording multiplexing parameters, in order to ensure that a specific pattern will always be detected, whatever the read-out multiplexing parameter. In this case, the read-out and/or recording device in accordance with the invention comprises, in addition to the associating means, means for selecting, among the recording multiplexing parameters, the multiplexing parameters that have to used for writing data in or reading-out data from the holographic information carrier. For example, the specific patterns corresponding to the recording multiplexing parameters that have to be used for writing data in or reading-out data from the holographic information carrier have a common additional characteristic that the specific patterns corresponding to recording multiplexing parameters that do not have to be used for writing data in or reading-out data from the holographic information carrier do not have.

Another solution to this problem is the following. It is possible to write the specific patterns in a portion of the recording medium of the holographic information carrier that is thinner than the rest of the recording medium. Due to this thickness difference, the Bragg selectivity is less stringent, and it is possible to choose the thickness of this thinner portion in such a way that a specific pattern is always detected, even if the read-out multiplexing parameter is in between two recording multiplexing parameters.

In order to achieve this, an holographic device in accordance with the invention comprises means for detecting in the holographic information carrier a first portion of recording medium having a first thickness and a second portion having a second, lower thickness and means for writing the specific patterns in said second portion. The specific patterns are thus written in a holographic information carrier comprising a recording medium comprising a first portion having a first thickness and a second portion having a second, lower thickness.

The following example describes how a read-out method may be implemented in such a holographic carrier comprising a first portion having a first thickness, in which data pages are recorded in accordance with the method described in FIG. 5, and a second portion having a second, lower thickness in which specific patterns are recorded. In the following example, the thickness is chosen in such a way that at least two specific patterns are detected, whatever the read-out multiplexing parameter. If the read-out multiplexing parameter is in between two recording multiplexing parameters, two specific patterns are detected and if the read-out multiplexing parameter is equal to a recording multiplexing parameter, three specific patterns are detected. In the latter case, one of the patterns has a much higher intensity than the two other patterns, that is the pattern associated with said recording multiplexing parameter.

When the specific book is read-out, if three patterns are detected, it means that the read-out multiplexing parameter is equal to the recording multiplexing parameter associated with the specific pattern having the highest intensity. If two patterns are detected, the read-out multiplexing parameter is modified until three specific patterns are detected. In order to perform this change in read-out multiplexing parameter, the intensities of the two detected patterns may be taken into account. Actually, the read-out multiplexing parameter is closer to the recording multiplexing parameter associated with the specific pattern having the highest intensity, and this information can be taken into account for modifying the read-out multiplexing parameter.

Although the specific patterns may be chosen randomly, as described in FIGS. 2, 3a and 3b, it is preferable to choose the specific patterns in such a way that they may be easily detected. For example, specific patterns as described in FIG. 2 can be easily retrieved even if the focus of the optical system is not perfect, because these patterns are homogeneous areas that cover a large number of pixels. Even if the optical system is not well aligned or not well focused, the read-out and/or recording device in accordance with the invention will be able to detect these specific patterns, which may be more difficult with, for instance, the patterns of FIG. 3b.

The means for associating the detected pattern with the corresponding recording multiplexing parameter may comprise means for reading a digital key provided by a user. For example, the specific patterns may be encrypted with an encryption key, and this key is required in order for the associating means to associate a detected pattern with the corresponding recording multiplexing parameter. This digital key may be sold to a user together with a holographic information carrier comprising the encrypted pre-recorded specific pattern. Therefore a non-authorized user will not be able to read data from or write data in this holographic information carrier.

The digital key may also comprise a table such as the tables depicted in FIG. 4a to 4c. As the associating means cannot function without this table, this means that the digital key will have to be provided by a user in order for the read-out and/or recording device in accordance with the invention to function.

Although the preceding description implies that, for each data page that has to be written or recorded in the holographic information carrier, the method described in FIG. 5 or 6 has to be applied, it is possible to apply the method of FIG. 5 or 6 only for one data page, or for a few data pages. Actually, once the read-out multiplexing parameter required for the first data page for instance has been retrieved with the method described in FIG. 5 or 6, it is possible to set the read-out multiplexing parameter required for another data page without detecting another pattern. Actually, in the example where the multiplexing parameter is the wavelength of the radiation source, the recording wavelengths will be standardized and the recording or read-out device in accordance with the invention will know that, between two successive recording wavelengths, there is a fixed difference of, for instance, 0.1 nanometers. Once the read-out wavelength λ1 required for reading out or recording the first data page has been determined, the wavelength required for reading out or recording the second data page is λ1+0.1 nanometers. Then, the recording or read-out device in accordance with the invention can modify the current driving the radiation source in such a way that the wavelength becomes λ1+0.1 nanometers, because the relation between the driving current and the wavelength is know in such radiation sources. It should be noted that this relation may depend on other parameters such that the ambient temperature. In this case, it is possible to measure the ambient temperature in order to adjust said relation. Alternatively, it is possible to measure, with the method of FIG. 5 or 6, the driving currents that are required for reading-out or recording a few data pages, and then to adjust the relation between the driving current and the wavelength as a function of said measures.

Any reference sign in the following claims should not be construed as limiting the claim. It will be obvious that the use of the verb “to comprise” and its conjugations does not exclude the presence of any other elements besides those defined in any claim. The word “a” or “an” preceding an element does not exclude the presence of a plurality of such elements.

1. A holographic device for writing data in and/or reading-out data from a holographic information carrier, said holographic information carrier comprising a plurality of patterns recorded with a plurality of corresponding recording multiplexing parameters, said holographic device comprising means for detecting said patterns and means for associating the detected patterns with the respectively corresponding recording multiplexing parameters.

2. A holographic device as claimed in claim 1, wherein said means for associating the detected patterns with the respectively corresponding recording multiplexing parameters comprise means for reading a digital key provided by a user.

3. A method for reading out a data page recorded with a first recording multiplexing parameter in a holographic information carrier comprising a plurality of patterns recorded with a plurality of corresponding recording multiplexing parameters, said method comprising the steps of:
a) operating (6a) at a first read-out multiplexing parameter;
b) detecting (6b) one of the patterns;
c) associating (6c) the detected pattern with the corresponding recording multiplexing parameter;
d) if the corresponding recording multiplexing parameter differs from the first recording multiplexing parameter, operating (6d) at a different read-out multiplexing parameter;
e) repeating steps b), c) and d) until the corresponding recording multiplexing parameter matches the first recording multiplexing parameter;
f) reading out (6f) the data page with the current read-out multiplexing parameter.

4. A method for recording a data page with a first recording multiplexing parameter in a holographic information carrier comprising a plurality of patterns recorded with a plurality of corresponding recording multiplexing parameters, said method comprising the steps of:
a) operating (5a) at a first read-out multiplexing parameter;
b) detecting (5b) one of the patterns;
c) associating (5c) the detected pattern with the corresponding recording multiplexing parameter;
d) if the corresponding recording multiplexing parameter differs from the first recording multiplexing parameter, operating (5d) at a different read-out multiplexing parameter;
e) repeating steps b), c) and d) until the corresponding recording multiplexing parameter matches the first recording multiplexing parameter;
f) recording (5f) the data page with the current read-out multiplexing parameter.

5. A method as claimed in claim 3, wherein the step of associating comprises a step of reading a digital key provided by a user.

6. A holographic device comprising means for storing a set of patterns associated with corresponding recording multiplexing parameters and means for writing said patterns in a holographic information carrier.

7. A holographic device as claimed in claim 6, said holographic device comprising means for detecting in the holographic information carrier a first portion of recording medium having a first thickness and a second portion having a second, lower thickness and means for writing said patterns in said second portion.

8. A holographic information carrier comprising a recording medium comprising a first portion having a first thickness and a second portion having a second, lower thickness.
